(19) United States
(12) Patent Application Publication
(10) Pub. No.: US 2015/0122293 A1
(43) Pub. Date: May 7, 2015

(54) METHOD AND APPARATUS FOR CLEANING VESSELS

(71) Applicant: OCS Technologies, L.L.C., Abbeville, LA (US)

(72) Inventor: Kenny DesOrmeaux, Abbeville, LA (US)

(73) Assignee: OCS Technologies, L.L.C.

(21) Appl. No.: 14/530,455

(22) Filed: Oct. 31, 2014

Related U.S. Application Data
(60) Provisional application No. 61/899,690, filed on Nov. 4, 2013.
(60) Provisional application No. 61/951,806, filed on Mar. 12, 2014.

(51) Int. Cl. B08B 9/093; B60P 1/04; B66C 23/02; F16M 11/18

(52) U.S. Cl. CPC B08B 9/0933; B08B 9/0936; F16M 11/18; B60P 1/04; B66C 23/02
USPC 134/21; 134/166 R; 29/426.2; 248/371; 414/494; 212/223

(57) ABSTRACT

A remotely-operable cleaning device having a claw assembly that can manipulate tools and instruments within a vessel. The cleaning device has collapsible tracks allowing it to be placed into small openings and to be expanded once it is passed through the small openings. The claw assembly may include opposing fingerlike projections. The cleaning device may be configured to handle forces from high pressure water lines. The cleaning device may be configured to assembly and disassembly via locking pins. The cleaning device may be transported and/or lowered into a vessel via a lift box or crane of the present invention. The crane may be configured for assembly at a location of interest.

### CROSS-REFERENCE TO RELATED APPLICATIONS

This application claims benefit of U.S. Provisional Application 61/899,690 filed Nov. 4, 2013, and U.S. Provisional Application 61/951,806 filed Mar. 12, 2014, which are incorporated herein by reference.

### FIELD

The present invention relates to methods and apparatuses for the removal materials from tanks or vessels, and in a particular though non-limiting embodiment, to machines and methods for removing solids, fluids, slurries, and sludge from the interior of a tank or other vessel.

### BACKGROUND

Conventional tank cleaning is often a long, stringent, hazardous and labor-intensive task. Conventional methods of tank and vessel cleaning require human exposure to dangerous environments.

Most currently available remote tank cleaning systems and associated methods include one or more nozzles configured to direct a fluid stream to dislodge, dilute, or dissolve settled solids from tank interiors. Generally, the purpose of these systems is to “fluidize” the settled solids and/or sludge to an extent that it can be easily pumped out. However, in some instances, settled solids and/or sludge inside tanks or other vessels cannot be removed, dissolved, or otherwise “fluidized” by the aforementioned conventionally available systems due to the composition of the solids, conditions inside the tank, lack of sufficient water pressure etc. In such situations, the solids and/or sludge must be physically/mechanically removed from the tank interior. Such methods may be time-consuming and may require one or more workers to physically enter the tank or vessel to mechanically dislodge the solids/sludge—a process that may place such workers in a dangerous and/or toxic environment and therefore at greater risk of exposure to health hazards and injuries. Even existing remote cleaning systems require humans to enter a tank to set-up, change and/or remove the system. Furthermore, depending on the material needing removal, multiple tools and systems may be required, forcing the work to be stopped and restarted while the equipment is changed out. Additionally, often times the cleaning equipment is too large to fit through the vessel's access point, requiring further operator exposure inside of the vessel in order to assemble the equipment parts.

Therefore, there is a long-felt, but unmet, need for a remote and/or automated apparatus and method for the removal of materials, including settled solids, fluids, slurries, or sludge, from a tank interior in order to increase the efficiency of such removal and to protect human workers from health risks and injuries.

### SUMMARY

In an exemplary embodiment of the present invention, a device for removing material from a vessel is provided, having: a chassis, including: a central member; a first track member substantially parallel to the central member and connected to the central member via first and second track extensions; and a second track member substantially parallel to the central member and connected to the central member via the first and second track extensions; a remotely controllable articulating assembly connected to a top surface of the central member of the chassis. The articulating assembly includes an arm having a first arm member with a first end pivotally connected to the chassis and a second end pivotally connected to a first end of a second arm member. The second arm member has a second end rotationally connected to a tool member. The first and second track extensions are configured to rotate from an expanded position substantially perpendicular to the central member to a collapsed position less than forty-five degrees relative to the central member. At least one of the chassis and the articulating assembly are controlled remotely by an operator external to the vessel.

The device may include a control system operatively connected to the device and configured to control movement of at least one of the assembly and the chassis. The device may have a width of less than 18 inches when in the collapsed position. The device may be configured to fit into a hole of approximately 17.75 inches. The device may have a width of approximately 22.5 inches when in the expanded position. The tool member may be a claw arm. The claw arm may include a first end connected to the second arm member and a second end having opposing curved finger extensions. The device may include a control system operatively connected to the device and configured to open and close the opposing curved finger extensions. The device may include twist lock pins connecting the first and second track members to the first and second track member extensions. The twist lock pins may have locking grooves.

In an exemplary embodiment of the present invention, a device for removing material from a vessel is provided, having: a chassis and a remotely controllable articulating claw assembly connected to the chassis, the claw assembly having at least two joints and configured to manipulate equipment in an interior portion of the vessel. The chassis may have first and second track members attached to a central member. The first and second track members may be configured to collapse such that the track members are close to the central member when in a collapsed position and extended away from the central member when in an expanded position. The claw assembly may include an arm having a first end pivotally connected to the chassis and a second end pivotally connected to a claw arm. The device may have a control system operatively connected to the device and configured to control movement of at least one of the claw assembly and the chassis. The chassis may include a moving arrangement configured to traverse an interior surface of the vessel and is remotely controllable. The chassis may be stationary. The claw arm may include a first end connected to the arm assembly and a second end having a plurality of opposing curved finger extensions.

The device may have a control system operatively connected to the device and configured to open and close the opposing curved finger extensions. The device may have a spray nozzle arrangement between opposing fingers of the claw arm. The claw assembly may be configured to fold into the chassis. The device may be configured to fit into a hole of about 17.75 inches. The device may be configured to fit into a hole of about 17.75 inches when in the collapsed position. The first and second track members may be attached to the central member via twist lock pins having locking grooves.

In an exemplary embodiment of the present invention, a method of removing material from a vessel interior is provided, having the steps of: folding a device into itself, the device including: a chassis; and a claw assembly; the claw assembly having first end pivotally connected to the chassis and a second end connect to a claw arm, the claw assembly and claw arm configured to fold and align proximate to the chassis; collapsing first and second tracks of the chassis, where the first and second tracks are configured to have collapsed and expanded positions; placing the device in a vessel; extending the first and second tracks into the expanded position; placing a vacuum assembly in the vessel; positioning the vacuum assembly within the vessel with the claw arm of the device; placing a water line having a spray nozzle in the vessel; manipulating the spray nozzle with the claw arm of the device to apply a water stream to the materials to be removed; applying a suction force from the vacuum assembly, such that the materials are moved from the vessel interior into the vacuum assembly; and removing the materials from the vacuum assembly through a hose. The water line may be a high pressure water line. The water line may provide approximately 100 GPM at approximately 900 PSI.

In an exemplary embodiment of the present invention, an apparatus for transportation, lowering and raising of a cleaning device is provided, having: a lift platform; a box having an open top; two lift arms connected to the box at first ends of the two lift arms such that the arms may rotate relative to the box and connected to the lift platform at second ends of the lift arms via a pair of pin slots on opposite sides of the lift platform; a pair of cylinders connected to an interior of the box and a bottom surface of the lift platform; a wench at a first end of the lift platform; and a plurality of leg extensions extending from lower corners of the box. The cylinders are configured to raise and lower the lift platform relative to the box. The lift platform is configured to form a top surface of the box when the lift platform is in a lowered position. The two lift arms are configured such that, when the lift platform is raised, the lift platform is angled such that the first end of the lift platform is at a highest point of the lift platform. The cleaning device may be secured to the lift platform via the wench.

The apparatus may have a plurality of wheels attached to the plurality of leg extensions. The leg extensions may be telescoping leg extensions. The apparatus may have a plurality of leveling pins attached to the plurality of telescoping leg extensions. The pair of cylinders may be configured to be contained within the box when the lift platform is fully lowered. At least two of the plurality of wheels may be swivel wheels. At least one of the plurality of wheels may include a locking mechanism.

In an exemplary embodiment of the present invention, a crane is provided, having: a base, including: an annular section extending vertically from a bottom section having a first ring, a second ring, and a third ring formed around the annular section; a first set of tubes arranged vertically between the first ring and the second ring forming a first set of pin holes; a second set of tubes arranged vertically between the second ring and the third ring forming a second set of pin holes; a plurality of leg extensions, each connected to at least one of the first and second sets of pin holes such that the plurality of leg extensions may rotate at a first end of the plurality of leg extensions relative to the first and second sets of pin holes; an extender connected to the annular section of the base and extending vertically from the base; a wench connected to the extender; an arm section, including: a connector secured to a top of the extender and extending vertically from the extender; an arm holder attached to a top portion of the connector and arranged substantially parallel to a surface upon which the crane is installed; an arm passing within the arm holder and configured to extend or contract relative to the arm holder; and a wench ring attached at one end of the arm. The extender is configured to rotate along a central axis relative to the annular section of the base.

The crane may have a plurality of leveling pins attached to the plurality of leg extensions. Each of the plurality of leg extensions may have a leg extension member. A circumference of the first ring may be substantially the same as a circumference of the second ring. A circumference of the second ring may be larger than a circumference of the second ring.

In an exemplary embodiment of the present invention, a system of removing material from a vessel is provided, having the steps of: disassembling the device of claim 25 by releasing the twist lock pins such that the first and second track members are separated from the first and second track extensions; transporting the device in separate pieces to a site for installation; assembling the device by connecting the first and second tracks to the first and second track extensions via the twist lock pins; dissembling the crane of claim 34 into the base, the extender, the wench, and the arm section; transporting the base, the extender, the wench, and the arm section to the site for installation; assembling the crane at the site for installation; connecting the wench of the crane to the device; lowering the device into the vessel via the wench; removing the material using the device; and raising the device out of the vessel via the wench.

### DESCRIPTION OF DRAWINGS

FIG. 1 is a schematic diagram of a system for cleaning according to an exemplary embodiment of the present invention.

FIG. 2 is a schematic diagram of a tank, control station, and cleaning device according to an exemplary embodiment of the present invention.

FIG. 3 is a top view of a cleaning device with tracks expanded according to an exemplary embodiment of the present invention.

FIG. 4 is a top view of the cleaning device shown in FIG. 3 with tracks collapsed.

FIG. 5 is an isometric view of the cleaning device shown in FIG. 3.

FIG. 6 is a side view of the cleaning device shown in FIG. 3 with an arm collapsed.

FIG. 7 is a side view of the cleaning device shown in FIG. 3 with an arm raised.

FIG. 8 is an isometric view of the cleaning device shown in FIG. 3.

FIG. 9 is a bottom isometric view of the cleaning device shown in FIG. 3.

FIG. 10 is a top view of a twist lock pin according to an exemplary embodiment of the present invention.

FIG. 10A is an isometric view of the twist lock pin shown in FIG. 10.

FIG. 10B is an isometric view of the twist lock pin shown in FIG. 10.

FIG. 10C is an isometric cross-section view of the twist lock pin shown in FIG. 10.

FIG. 11 is an isometric view of a lift box according to an exemplary embodiment of the present invention.

FIG. 12 is an isometric view of a lift box according to an exemplary embodiment of the present invention.

FIG. 13 is an isometric view of a crane according to an exemplary embodiment of the present invention.

FIG. 14 is a top view of the crane shown in FIG. 13.

FIG. 15 is a side view of the crane shown in FIG. 13.

FIG. 16 is an isometric view of a vacuum head according to an exemplary embodiment of the present invention.

FIG. 17 is a front view of the vacuum head shown in FIG. 16.

FIG. 18 is an isometric view of a vacuum head attached to a cleaning device according to an exemplary embodiment of the present invention.

### DETAILED DESCRIPTION

Like reference characters denote like parts in the several drawings.

Example embodiments of the present invention include a remotely-operated tracking device that provides a claw assembly and/or claw arm configured to manipulate tools and/or instruments within a vessel. Example embodiments of the present invention provide for the manipulation and/or placement of a vacuum within the vessel. Example embodiments of the present invention provide for manipulation of high pressure water/cleaning fluid lines and other tools. The high pressure lines may provide sufficient pressure to dislodge sludge and/or debris within a vessel that could not be dislodged with traditional fluid lines or fluidization methods. Embodiments of the present invention may include twist lock pins for attachment of tracks to the tracking device such that the tracks may be easily removed allowing for the tracking device to be disassembled and relocated in separate pieces. The tracking device may be taken to an install location using a lift box according to an example embodiment of the present invention. The tracking device may be lowered into a vessel using a squid crane according to an example embodiment of the present invention. The squid crane may allow for access to locations that could not be accessed with a lift box, traditional wench or other crane device.

Not only can removal tasks be accomplished in a remote, safe manner, but they may be effectively and efficiently performed simultaneously or consecutively with a single operator. Moreover, removal may be accomplished without a human entering a vessel. To facilitate effective and efficient services, in accordance with an exemplary embodiment of the present invention, a cleaning device may be equipped with a claw assembly and/or claw arm having opposing finger-like extensions capable of grasping equipment and/or tools inside the vessel. Other securing mechanisms may be used other than a claw. Additionally, according to exemplary embodiments of the present invention, the cleaning device may be configured to change its shape such that it can enter a tank or vessel through an opening with minimal space. For example, accordingly to an exemplary embodiment of the present invention, a device may be provided that folds into itself such that its largest dimensions allow it to enter a cylindrical access hole with a diameter of about 17.75 inches. In exemplary embodiments of the present invention provide collapsible tracks that can be collapsed such that the cleaning device may be passed through an access hole with a diameter of about 17.75 inches. The collapsible tracks may be expanded once the cleaning device is inside the vessel to be cleaned. After expansion, the tracks provide a wider base than could be passed through the access hole, increasing the stability of the cleaning device and allowing it to withstand larger forces (such as high pressure water lines). Further, according to example embodiments of the present invention, the device may be driven with electric over hydraulic directional control valves. In example embodiments, the hydraulic directional control valve used may support up to 30 gallons per minute at 5000 pounds per square inch, which is the equivalent of about 87.515 horse power. However, other drive sources can be used, such as pneumatics, electronics, hydraulic over hydraulic, or pneumatics over hydraulics, or any applicable combination thereof. The unique device and system configuration, along with the novel tools/attachments discussed herein, provide for a high power, compact and effective cleaning device and system.

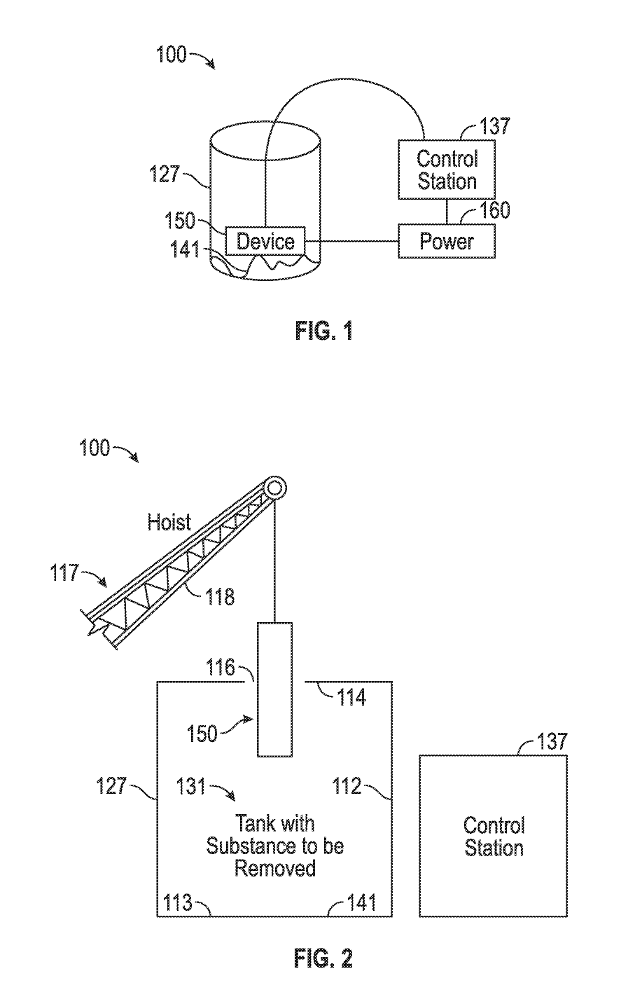

FIG. 1 illustrates an exemplary embodiment of a system 100 for cleaning a vessel. A cleaning device 150 is remotely controlled by an operator at the control station 137, external to the vessel 127. The control station 137 is operatively connected to the cleaning device 150 and transmits signals to the device 150, based on the operator's input at the control station 137. A display device is provided at the control station 137, wherein the operator can monitor the device 150 inside of the vessel and make any necessary adjustments to the system.

The control station 137 and device 150 are operatively connected to a power source 160 to provide power for the system 100. According to example embodiments, the device 150 is driven with electric over hydraulic directional control valves. However, other drive sources can be used, such as pneumatics, electronics, hydraulic over hydraulic, or pneumatics over hydraulics, or any applicable combination thereof.

FIG. 2 illustrates a control station 137 that is preferably provided external to vessel 127. Control station 137 includes such suitable control technologies for remotely controlling, including but not limited to: the movement of a cleaning device; movement of tracks of the cleaning device; collapsing and/or expanding tracks of the cleaning device; and manipulation of a claw arm and/or claw assembly of the cleaning device. In other embodiments, control station 137 may include a programmable logic controller (PLC) configured to deliver control signals to device 150 to control the movement of any movable components of device 150. Accordingly, such PLC or other suitable controller may be configured to convert user inputs into control signals for operating any movable component of device 150. User input signals may be provided from any suitable user interface device, such as buttons, switches, joysticks, etc. Further, user input signals and control signals may be either digital or analog, and the PLC or other suitable controller may be configured to accept and/or output either. In some embodiments, control station 137 further includes a monitor configured to display video from a camera mounted in the tank interior 131, thereby allowing a user to view the movements of device 150. According to an exemplary embodiment, an umbilical cord is provided for communicating between control station 137 and device 150. In other embodiments, communication may be established between control station 137 and device 150 via a wireless connection, such as RF, infrared, or any other suitable communication technology.

Tank cleaning system 100 may be used to clean settled solids from a storage tank 127 or storage vessel 127. Such a tank or vessel 127 may contain a material 141 that has settled into solid and/or semi-solid matter, such as drilling mud. Tank 127 includes a side wall 112, bottom or bottom wall 113 and a top wall or roof 114. Interior 131 contains the settled material 141 to be removed. Tank 127 may further include an access opening or entry hatch 116 for gaining access to interior 131. In certain embodiments opening 116 may be a part of roof or top wall 114. Entry hatch 116 may have a limited diameter opening which may be approximately 18 inches. A lifting device such as a hoist, crane, wheeled crane, mobile crane or any other such suitable device may be used to lift cleaning device 150 into tank 127. In certain embodiments, such a lifting device or crane 117 may provide boom 118, lifting lines and a lifting hook. Such a lifting device 117, boom 118, lifting line and hook are known and commercially available.

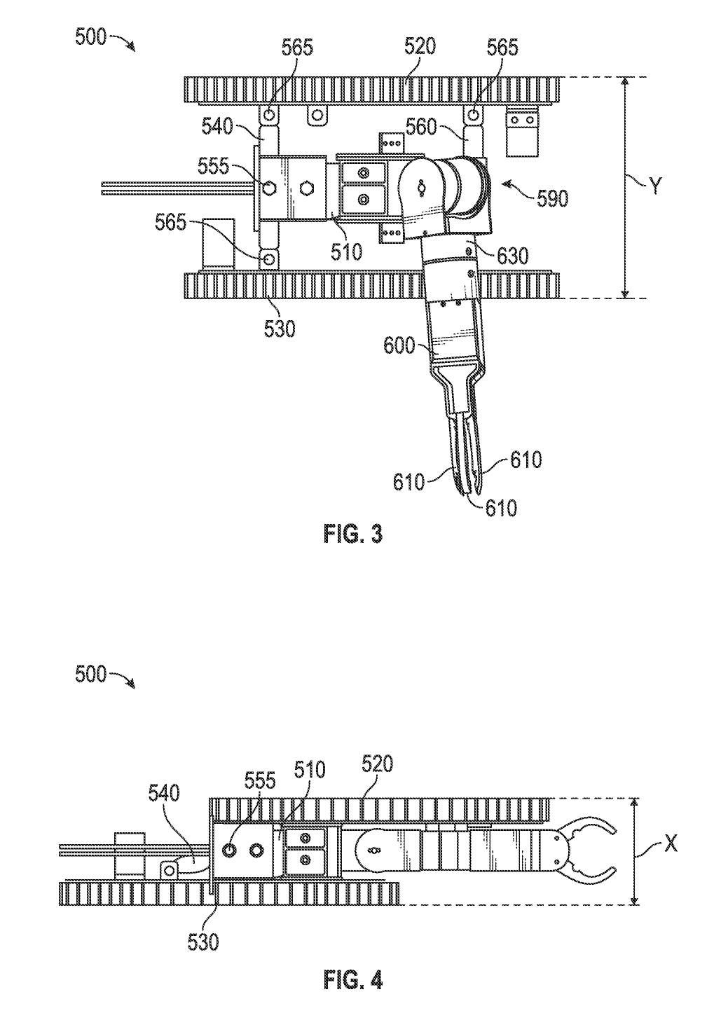

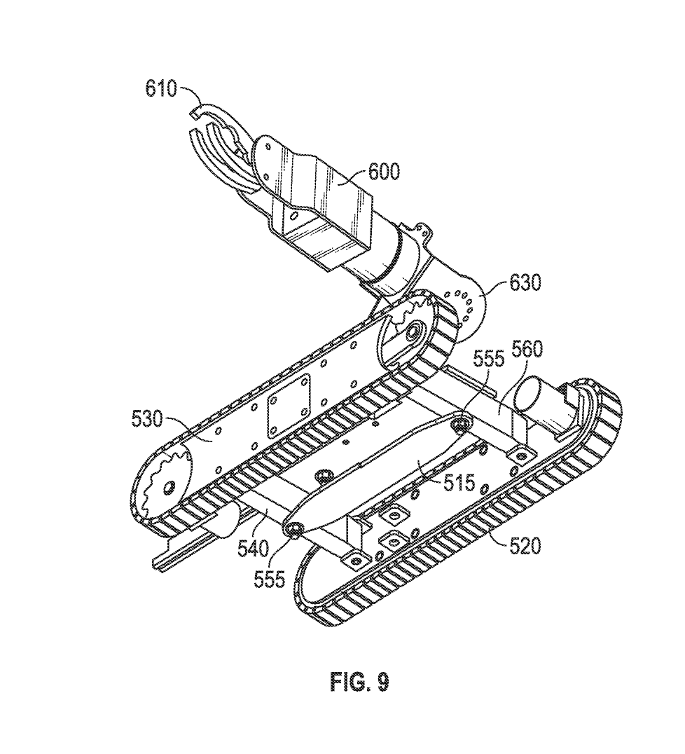

In the example embodiment of the present invention shown in FIG. 3, a device 500 is provided having a chassis with a first central member 510, a second central member 515 (see, e.g., FIG. 9), and first and second track members 520 and 530 substantially parallel to first central member 510. First track member 520 and second track member 530 are connected to first central member 510 and second central member 515 via first and second track extensions 540 and 560. First and second track extensions 540 and 560 connect to first central member 510 and second central member 515 via central pins 555 such that the track extensions may rotate along the axes of central pins 555. First and second track extensions 540 and 560 connect to first track member 520 and second track member 530 via track pins 565 such that first and second track extensions 540 and 560 may rotate relative to first and second track members 520 and 530.

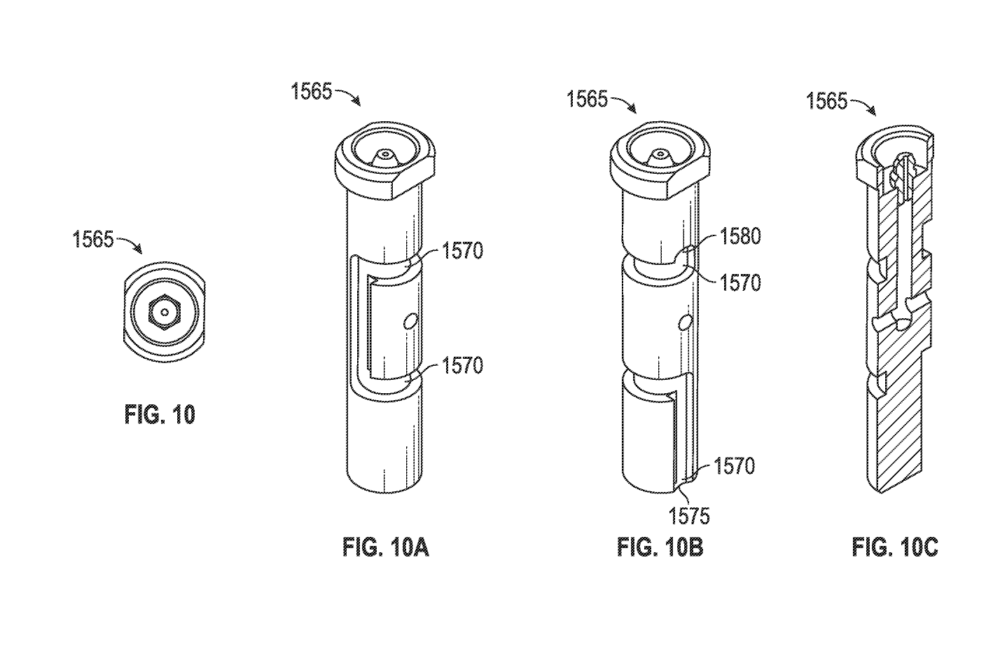

In the alternative, twist lock pins 1565 (FIGS. 10 to 10C), having a quick release bolt, may be used in place of track pins 565 to connect first track member 520 and second track member 530 to the first and second track extensions 540 and 560. Twist lock pins 1565 have a locking groove 1570 along an outer surface of the twist lock pin 1565. At a bottom of the twist lock pin 1565, there is an opening 1575 of the locking groove 1570, which may receive a locking bolt (not shown) or other locking extension within a pin aperture of the first and second track extensions 540 and 560. Twist lock pin 1565 may be lowered and/or twisted such that the locking bolt or locking extension passes within the locking groove 1570 until the locking bolt or locking extension reaches and engages locking end 1580 of the locking groove 1565. Twist lock pins 1565 also allow first and second track extensions 540 and 560 to rotate relative to first and second track members 520 and 530 but further provide for quick disconnection of the pins such that first and second track members 520 and 530 may be readily disconnected from the rest of device 500. By disconnecting first and second track members 520 and 530, device 500 may be relocated in separate pieces. With twist lock pins 1565, a single worker may disassemble device 500 and carry device 500, in parts, to a location of choice. Separation of first and second track members 520 and 530 from the rest of device 500 also allows for the device 500 to be assembled at a location that would have been difficult to access if the device had to located in tact utilizing a separate locating device such as a wench or a crane. In embodiments of the present invention, the device 500 may weigh up to 800 pounds. Moreover, disassembly allows for easier cleaning of device 500 after use.

In an expanded position as shown in the exemplary embodiment of FIG. 3, the track extensions are substantially perpendicular to first central member 510 and the first and second track members 520 and 530. When the track extensions are rotated, the first and second track members 520 and 530 may be pulled closer to first central member 510. See, e.g., FIG. 4. Although the track extensions 540 and 560 are shown as single axes stretching between first and second track members 520 and 530 and connected to first and second central members 510 and 515 via central pins 555, embodiments may have multiple track extensions extending from sides of a single central member. Track extensions could each have a hinge point on each side of the central member allowing the track extensions to fold onto themselves and pull the track members closer. Alternatively, track extensions may be configured to have adjustable protrusions from central member 510.

When collapsed such as the embodiment shown in FIG. 4, the device has a narrow width X, which is configured to allow the device to fit into a manhole. Width X may be approximately 17 inches. When expanded such as the embodiment shown in FIG. 3, the device has a track width of Y, which may be 22.5 inches. First and second track extensions 540 and 560 allow first and second track members 520 and 530 to be collapsed during placement of the device in a vessel through an access hole while allowing for an expanded track base once the device is in the vessel. The narrow width X permits manipulation and placement while expanded width Y permits increased base width and stability during operation. Because the device can increase its width from X to Y, the device can handle certain tools and materials it would not be able to handle with a narrower base. For example, once expanded, the device can be used to manipulate a high pressure water line, which may provide a water flow of approximately 100 GPM and approximately 900 PSI. Such a high pressured water line would tip over a device having a narrow width. The expanded position may allow the device to manipulate a pre-wash system, e.g., the GAMMAJET® system by Alfa Laval Group, which may be used for a pre-wash cycle prior to a high pressure cleaning fluid line wash. The base structure of the device is configured to support pre-wash systems that use high pressure fluids. The tracks may allow the device to be moved within the vessel and the device may be moved to provide additional control of a tool and/or water line/cleaning fluid line connected to the device. Alternatively, the device may be stationary within the vessel. When the device is stationary, or unable to move within a limited space within the vessel due to obstructions, e.g., vessel structural members, the wide base and use of high pressure cleaning fluids is effective for cleaning distant parts of a vessel that could not be effectively cleaned with lower pressure systems. Indeed, because high pressures are required for such cleaning, the wide expanded base is critical to maintain the stability of the cleaning device. High pressure fluid lines held by remote arms maneuvering in and out of various positions assert a large moment about the wheel base that would cause it to overturn if the base structure was not wide enough to counter such forces.

In embodiments of the present invention, various tools can be lowered into the tank and grabbed by a claw or other securing mechanism attached to the arm. These tools, including high pressure cleaning fluid hoses, can be fished down to the claw and then fished back out when work is complete. In embodiments of the present invention a vacuum assembly, separate from the cleaning device, can be lowered into the tank and the cleaning device can direct material to be removed to the vacuum assembly.

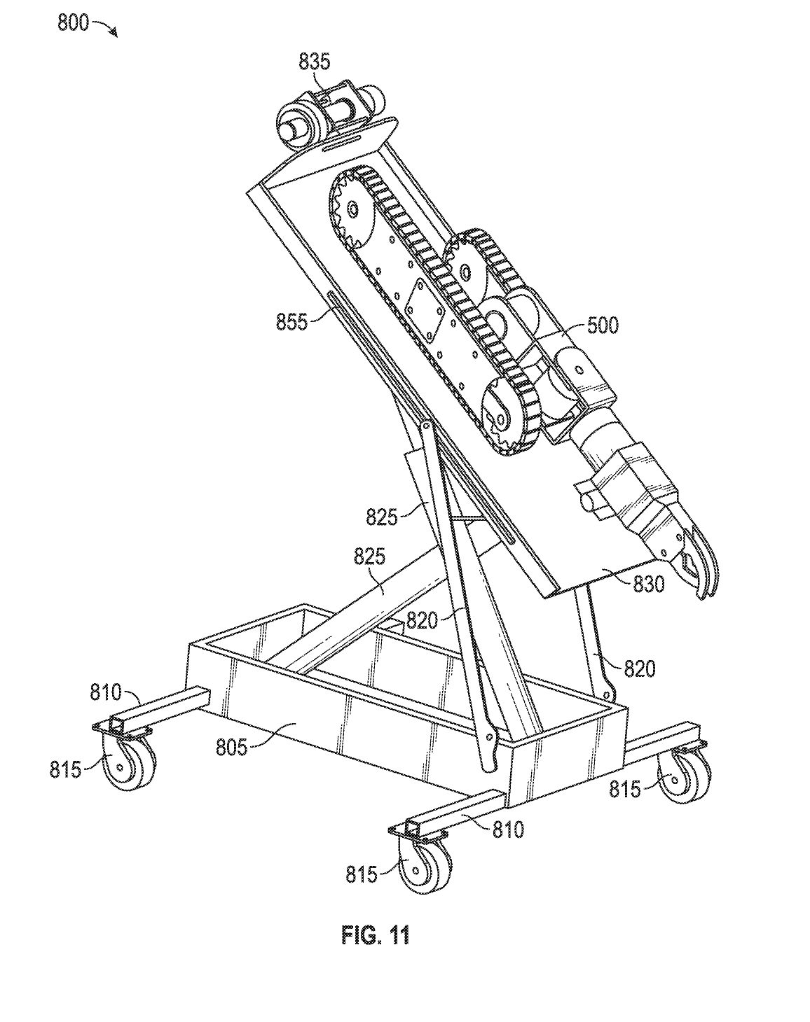

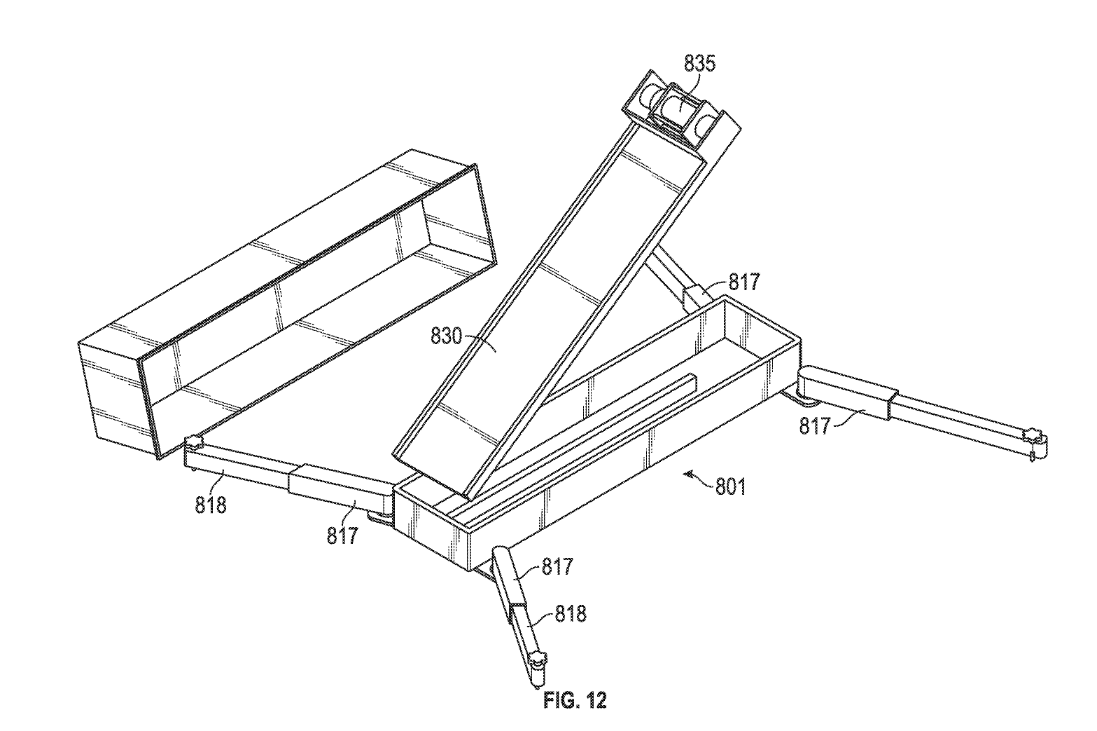

Embodiments of the present invention include a lift box 800 that may be used to transport device 500 to a location and/or lower device 500 into a vessel for cleaning. See, e.g. FIGS. 11 and 12. Lift box 800 may have a lift platform 830 upon which device 500 may be placed as shown in FIG. 11. Device 500 may be secured upon lift platform 830 via wench 835 attached at one end of lift platform 830. Wench 835 may also be used to lower device 500 into a vessel. Lift platform 830 is configured such that it is relatively flat with respect to box 805 when in a lowered position. Lift platform 830 is attached to box 805 via two lift arms 820. At a first end, lift arms 820 may be connected to box 805 via pins or bolts, allowing for lift arms 820 to rotate along the axis of the pins or bolts. At a second end, lift arms 820 may be connected to lift platform 830 via pin slot 855 that runs along a majority of a length of lift platform 830 such that the second end may slide within pin slot 855. In this way, lift arms 820 are configured and connected to allow lift platform 830 to be raised via cylinders 825 such that lift platform 830 is angled downward with wench 835 at an elevated point of lift platform 830. Cylinders 825 are configured to raise and/or lower lift platform 830 and be fully contained within box 805 when lift platform 830 is fully lowered upon box 805.

Lift box 800 may have leg extensions 810 extending from corners of box 805 and having wheels 815 attached thereto, which may be swivel wheels and may include locking mechanisms to prevent rolling. See, e.g., FIG. 11. Wheels 815 allow for box 805 to be used to roll device 500 to a selected site. Once at location, wheels 815 may be locked or removed, lift platform 830 raised, and device 500 lowered into the vessel using wench 835. Alternatively, lift box 801 may have angled telescoping leg extensions 817. See, e.g., FIG. 12. At ends of telescoping leg extensions 817, leveling pins 818 may be provided, allowing for the height of each leveling pin 818 to be adjusted to address unlevel conditions and/or terrain. Lift box 801 may loaded with device 500 and deployed to a location that permits rolling access. For example, many vessels in need of cleaning have access points that can be reached by rolling lift box 801 up to the point of deployment. The adjustable legs 817 of lift box 801 allow for adjustments to the circumstances for secure and stable deployment of device 500.

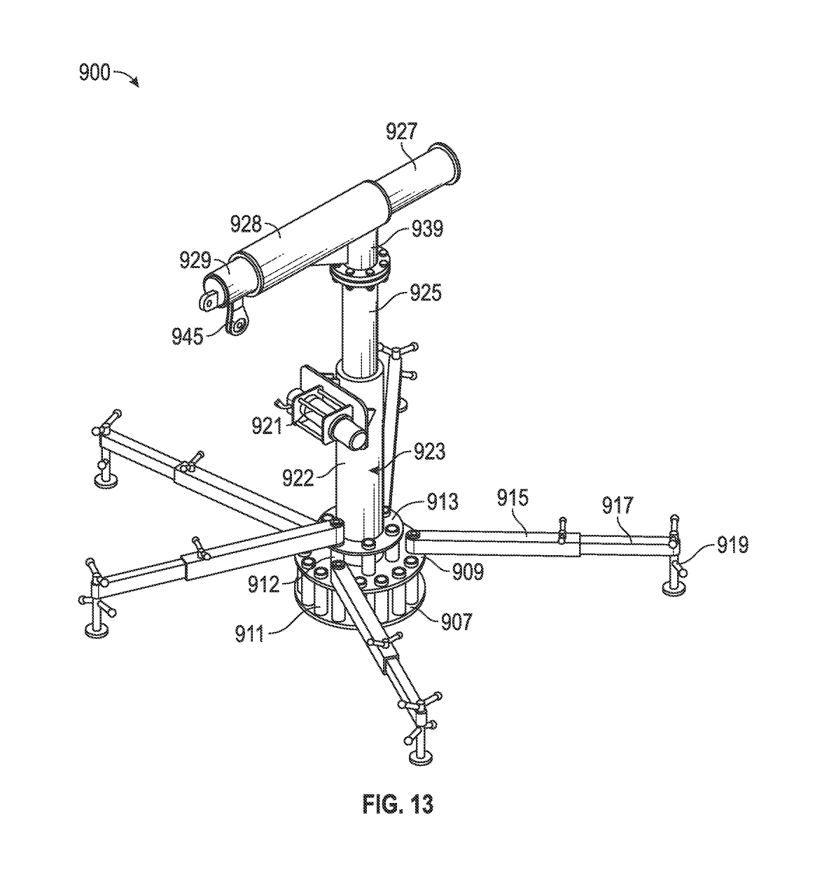

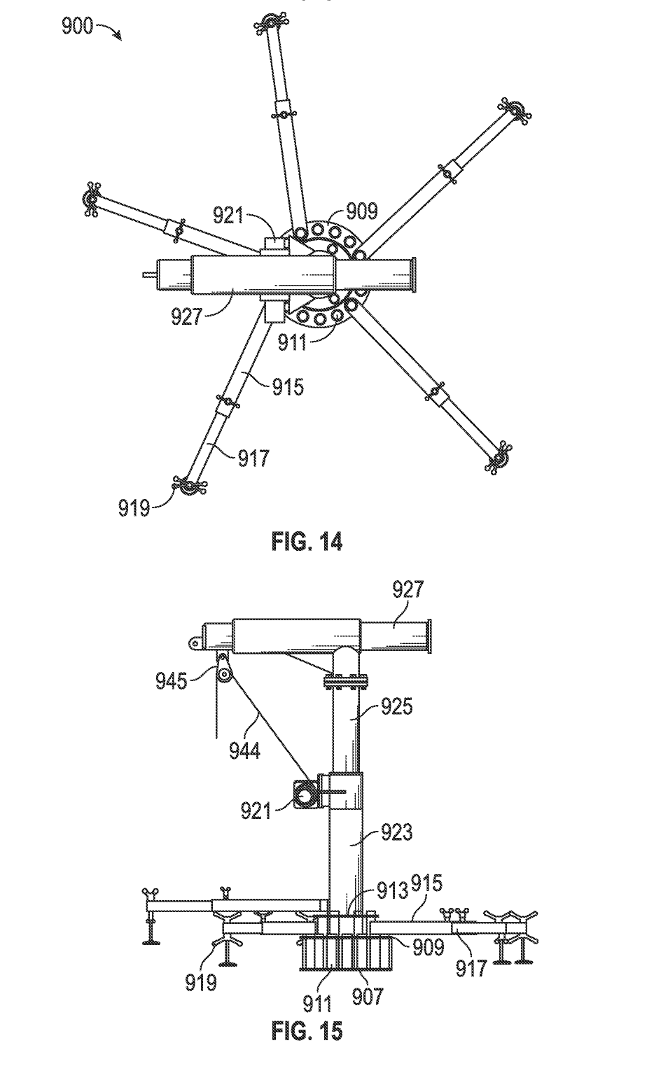

In embodiments of the present invention, squid crane 900 is provided, which may be employed to lower and/or raise materials such as device 500. See, e.g., FIGS. 13 to 15. Squid crane 900 may be configured to be separated into a plurality of parts and assembled on location. Squid crane 900 may be made of stainless steel. Squid crane 900 has a base 923 having annular section 922 extending from a bottom section having a first ring 907, second ring 909 and third ring 913. First ring 907 and second ring 909 are substantially the same diameter. Vertically aligned between first ring 907 and second ring 909 are a first set of tubes 911 forming a first set of pin holes along the circumferences of first ring 907 and second ring 909. Third ring 913 has a diameter less than the diameter of second ring 909. Vertically aligned between second ring 909 and third ring 913 are a second set of tubes 912 forming a second set of pin holes along the circumference of third ring 913. Connected to the first and second set of pin holes are a plurality of telescoping leg extensions 915 having extension members 917 and leveling pins 919. The plurality of telescoping leg extensions 915 are connected to the first and second set of pin holes via pins such that telescoping leg extensions 915 may freely rotate. The rotations of the telescoping leg extensions 915 and leveling pins 919 allow for the telescoping leg extensions 915 to be connected in a plurality of configurations allowing for adjustment to the surfaces upon which squid crane 900 may be utilized.

Extender 925 is an annular extension connected to annular section 922 such that extender 925 may rotate along a central annular axis relative to annular section 922. Wench 921 may be attached to extender 925 and configured such that a wire 944 of wench 925 is passed through wench ring 945.

Attached to extender 925 is arm section 927 having connector 939 secured to a top of extender 925. Arm holder 928 is attached and may be perpendicular to connector 939 such that arm holder 928 is substantially parallel to a surface upon which squid crane 900 is installed. Other configurations of arm holder 928 are possible. Passing within arm holder 928 is arm 929 with wench ring 945 attached at one end of arm 929. Arm 929 is configured such that is may extend or contract with regard to arm holder 928, allowing the location of wench ring 945 to be laterally adjusted with respect to base structure 923.

Squid crane 900 may be quickly dissembled into base structure 923, extender 925, wench 921 and arm section 927. With the total weight of squid crane being such that a single worker can locate and assemble the pieces of the squid crane 900 at a desired location. This is particularly helpful for situations where the deck is cluttered and/or the location is difficult to access. Allowing the squid crane 900 to be transported in pieces and assembled on location substantially increases the areas of access for squid crane 900. Squid crane 900 may be utilized to lower and/or raise device 500 into or out of a vessel having a difficult access point location. In example embodiments of the present invention, squid crane 900 is rated for up to 1000 pound loads and has a safety factor of 2.5.

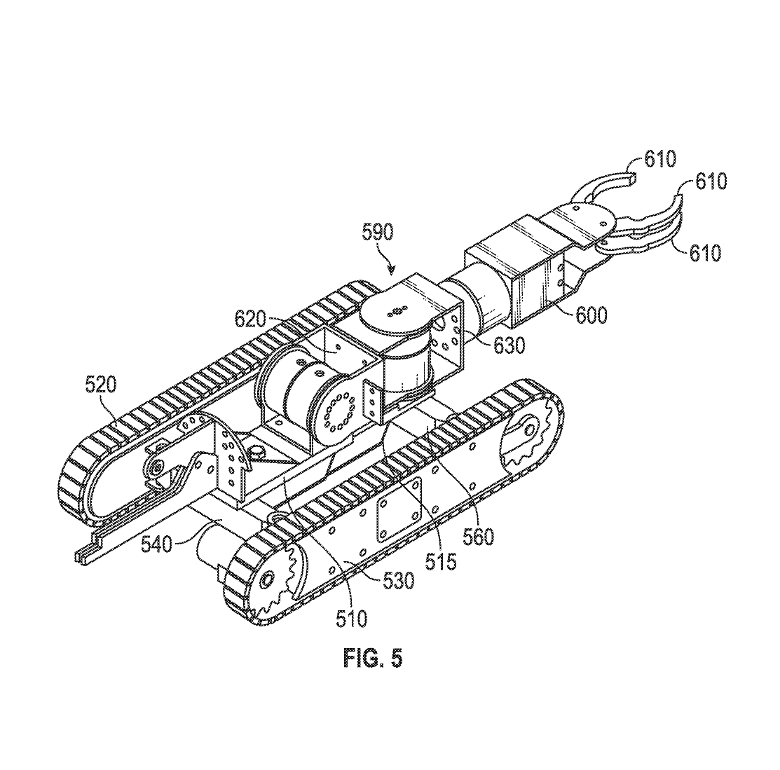

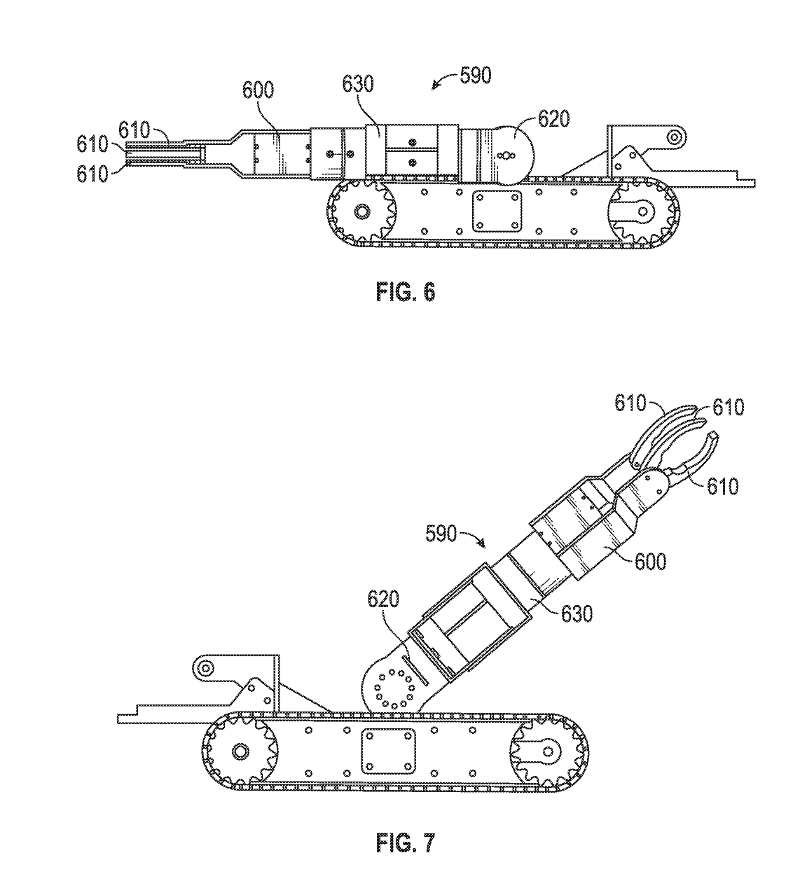

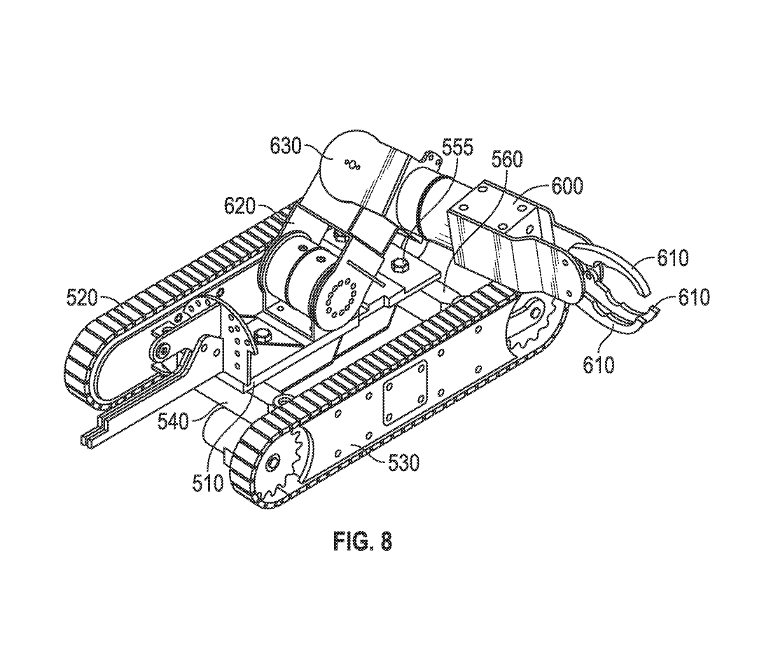

In embodiments of the present invention, a device may include an articulating assembly 590 attached to a top surface of the chassis. See, e.g., FIGS. 3 to 9. Articulating assembly 590 may be pivotally connected to the chassis or the first central member 510 of the chassis. The articulating assembly 590 has a first arm member 620 having a first end pivotally connected to the first central member 510 and a second end pivotally connected to a first end of a second arm member 630. See, e.g., FIG. 5. The second arm member has a second end rotationally connected to a first end of tool member 600. The tool member 600 may be a claw arm having a plurality of opposing curved finger extensions 610 at a second end. Finger extensions 610 are configured such that may be manipulated from open to closed positions and may be used to grab or manipulate a tool or other instrument. The articulating assembly 590 may have three joints or axes of rotation. Connections between first central member 510 and first arm member 620 and between first arm member 620 and second arm member 630 may utilize sealed live swivel pivot joints. The pivot joints, in certain embodiments, are sealed by covering them with rugged rubber bellows. These bellows allow the swivels to pivot about 80 degrees of a 360 degree rotation and maintain an adequate seal for pumping and vacuuming materials. Articulating assembly 590 may be configured such that articulating assembly 590 may be folded into or along first central member 510. See, e.g., FIG. 5. Articulating assembly 590 may be placed in a folded position when the device is being placed into or removed from the vessel through an access hole. Articulating assembly 590 may be configured for remote manipulation such that finger extensions 610 may be used to grab and manipulate objects within a vessel.

In embodiments of the present inventions, methods of removing material from a vessel interior are provided having steps of: folding a device into itself, the device including: a chassis; and a claw assembly; the claw assembly having first end pivotally connected to the chassis and a second end connected to a claw arm, the claw assembly and claw arm configured to fold and align proximate to the chassis; collapsing first and second tracks of the chassis, where the first and second tracks are configured have collapsed and expanded positions; placing the device in a vessel; extending the first and second tracks into the expanded position; placing a vacuum assembly in the vessel; positioning the vacuum assembly within the vessel with the claw arm of the device; placing a water line having a spray nozzle in the vessel; manipulating the spray nozzle to apply a water stream to the materials to be removed; applying a suction force from the vacuum assembly, such that the materials are moved from the vessel interior into the vacuum assembly; and removing the materials from the vacuum assembly through a hose. Embodiments of the present invention include the use of high pressure water lines, which provide approximately 100 GPM at approximately 900 PSI. The high pressure lines allow removal of materials not previously removed with lower water pressures and volumes. Expanding the base of the device allows for manipulation of a high pressure line without pushing over the device. The device may be moved around the vessel to provide additional water line direction or the device may remain stationary within the vessel.

In embodiments of the present invention, a system of cleaning a vessel in need of cleaning is provided. In certain embodiments, device 500 may be transported to a desired location via lift box 800 and dropped into the vessel using wench 835. In other embodiments, device 500 may be disassembled, by separating the tracks via twist lock pins, and carried to a desired location in separate pieces. Once at the desired location, device 500 may be reassembled. Disassembly and transport may provide substantial benefits over utilizing a separate device to locate an assembled device 500. Particularly, cluttered decks and/or difficult to reach locations may make transport of device 500 using a transportation device impractical or impossible. Disassembly substantially increases the areas of access for device 500. Once assembled on site, device 500 may be lowered and/or raised using lift box 801 or squid crane 900. Squid crane 900 may also be transported in pieces and assembled on site, substantially increasing the areas of access for squid crane 900. Accordingly, use of both squid crane 900 and disassembled device 500 creates overall improvement with regard to access to difficult locations.

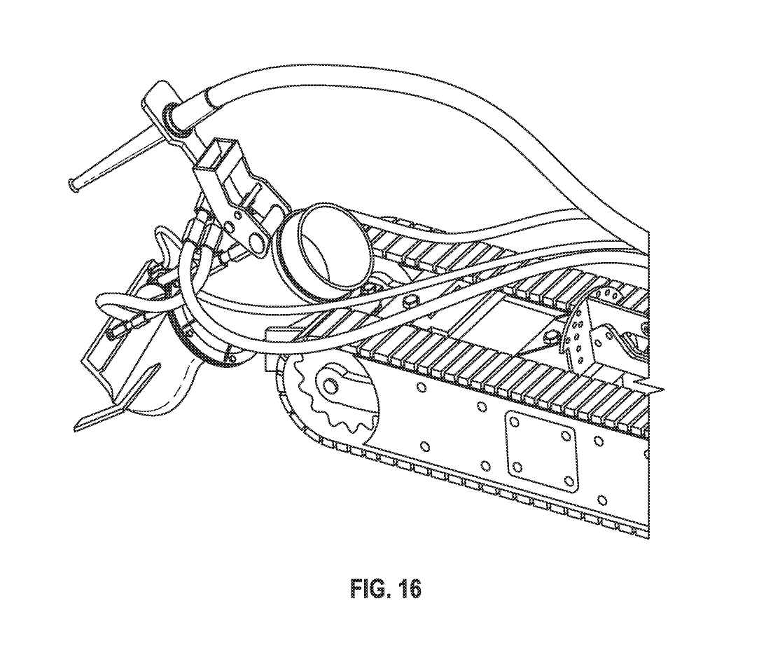

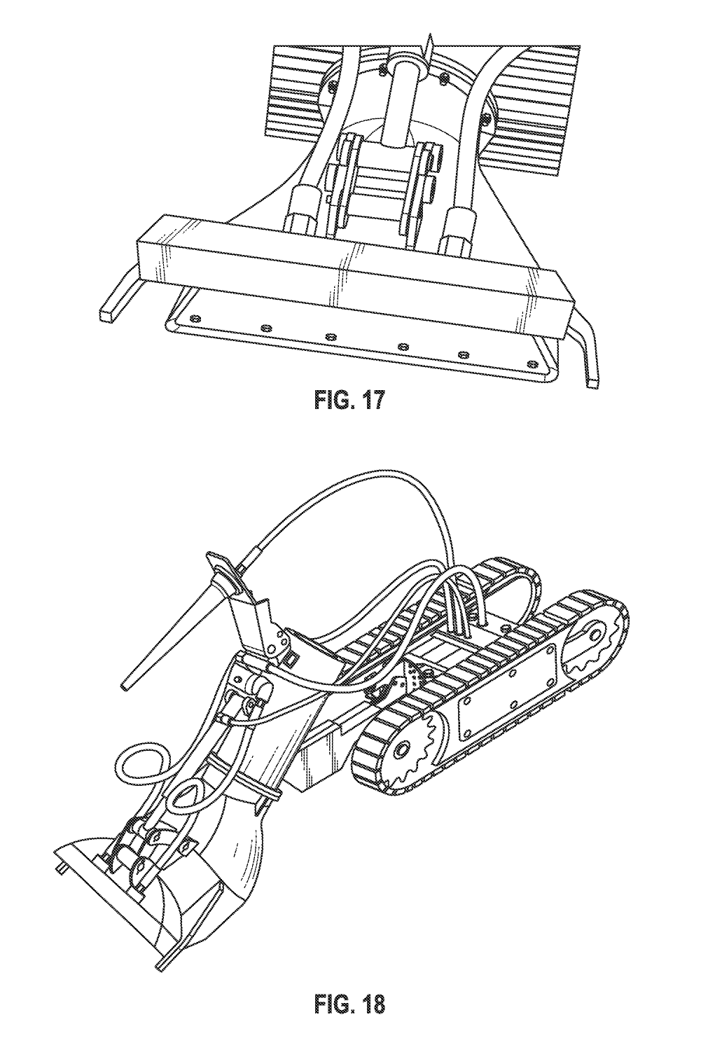

According to another embodiment for a cleaning device, a remotely operated tracking device may be deployed to clean a vessel such as the embodiments disclosed in FIGS. 16 to 18. The apparatus disclosed in includes tracking members and a vacuum head attached to track members. The vacuum head is attachable to a vacuum hose and the device may be remotely controlled within a vessel. It may be deployed, integrated with and operated in accordance with the systems disclosed herein and in U.S. patent application Ser. No. 13/135,018, filed on Jun. 23, 2011, which application is incorporated herein by reference. The vacuum head shown in FIGS. 16 and 17 may be attached to device 500 or to any of the embodiments of the '018 application or any combination of the features thereof.

The foregoing embodiments are presented by way of example only. While the embodiments are described herein with reference to various implementations and exploitations, it will be understood that these embodiments are illustrative and that the scope of the invention(s) is not limited to them. In general, embodiments of a method and/or apparatus for removing material from storage tanks as described herein may be implemented using methods, facilities, and devices consistent with any appropriate structural or mechanical system(s). Many variations, modifications, additions, and improvements are possible and the various aspects of the different embodiment described herein may be incorporated into each of the different exemplary embodiments described as appropriate to accomplish to tasks specified herein.

For example, plural instances may be provided for components, operations or structures described herein as a single instance. Boundaries between various components, operations and functionality are depicted somewhat arbitrarily, and particular operations are illustrated within the context of specific illustrative configurations. Other allocations of functionality will also fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A device for removing material from a vessel, comprising: a chassis and a remotely controllable articulating claw assembly connected to the chassis, the claw assembly having at least two joints and configured to manipulate high pressure spray equipment in an interior portion of the vessel, wherein the chassis includes first and second track members attached to a central member, the first and second track members configured to hinge about a central member such that they move in opposite directions and collapse close to the central member and expand away from the central member, wherein the chassis is stable in the expanded position and subjected to forces produced by the high pressure spray equipment.

2. The device of claim 1, wherein the first and second track members are removably attached to the chassis.

3. The device of claim 1, further comprising twist lock pins connecting the first and second track members to a first and a second track member extensions that operatively connect the first and second track members to the central member, wherein the twist lock pins have locking grooves.

4. A device for removing material from a vessel, comprising:
a chassis having a central member;
a first track member substantially parallel to the central member and connected to the central member via first and second track extensions; and
a second track member substantially parallel to the central member and connected to the central member via the first and second track extensions;
a remotely controllable articulating assembly connected to a top surface of the central member of the chassis;
wherein the articulating assembly includes an arm having a first arm member with a first end pivotally connected to the chassis and a second end pivotally connected to a first end of a second arm member;
wherein the second arm member has a second end rotationally connected to a tool member;
wherein the first and second track extensions are configured to rotate from an expanded position substantially perpendicular to the central member to a collapsed position less than forty-five degrees relative to the central member; and
wherein at least one of the chassis and the articulating assembly are controlled remotely by an operator external to the vessel.

5. The device of claim 4, further comprising a control system operatively connected to the device and configured to control movement of at least one of the assembly and the chassis.

6. The device of claim 4, wherein device has a width of less than 18 inches when in the collapsed position.

7. The device of claim 6, wherein the device is configured to fit into a hole of approximately 17.75 inches.

8. The device of claim 4, wherein the device has a width of approximately 22.5 inches when in the expanded position.

9. The device of claim 4, wherein the tool member is a claw arm.

10. The device of claim 9, wherein the claw arm comprises a first end connected to the second arm member and a second end having opposing curved finger extensions.

11. The device of claim 10, further comprising a control system operatively connected to the device and configured to open and close the opposing curved finger extensions.

12. The device of claim 4, further comprising: twist lock pins connecting the first and second track members to the first and second track member extensions;
wherein the twist lock pins have locking grooves.

13. A device for removing material from a vessel, comprising: a chassis and a remotely controllable articulating claw assembly connected to the chassis, the claw assembly having at least two joints and configured to manipulate equipment in an interior portion of the vessel, wherein the chassis includes first and second track members attached to a central member, wherein the first and second track members are configured to collapse such that the track members are close to the central member when in a collapsed position and extended away from the central member when in an expanded position.

14. The device of claim 13, wherein the claw assembly includes an arm having a first end pivotally connected to the chassis and a second end pivotally connected to a claw arm.

15. The device of claim 13, further comprising a control system operatively connected to the device and configured to control movement of at least one of the claw assembly and the chassis.

16. The device of claim 13, wherein the chassis includes a moving arrangement configured to traverse an interior surface of the vessel and is remotely controllable.

17. The device of claim 14, wherein the claw arm comprises a first end connected to the arm assembly and a second end having a plurality of opposing curved finger extensions.

18. The device of claim 17, further comprising a control system operatively connected to the device and configured to open and close the opposing curved finger extensions.

19. The device of claim 18, further comprising a spray nozzle arrangement between opposing fingers of the claw arm.

20. The device of claim 14, wherein claw assembly is configured to fold into the chassis.

21. The device of claim 14, wherein the device is configured to fit into a hole of about 17.75 inches.

22. The device of claim 14, wherein the device is configured to fit into a hole of about 17.75 inches when in the collapsed position.

23. The device of claim 14, wherein the first and second track members are removably attached to the chassis

24. The device of claim 14, wherein the first and second track members are attached to the central member via twist lock pins having locking grooves.

25. A method of removing material from a vessel interior, comprising the steps of:
folding a device into itself, the device including: a chassis; a first track connected to a central member of the chassis; a second track connected to the central member of the chassis; and a claw assembly; the claw assembly having first end pivotally connected to the chassis and a second end connect to a claw arm, the claw assembly configured to fold and align proximate to the chassis;
collapsing the first and second tracks proximate to the chassis;
placing the device in a vessel;
extending the first and second tracks into an expanded position to form a stable base;
placing a vacuum assembly in the vessel;
positioning the vacuum assembly within the vessel using the claw assembly;
placing a fluid line having a spray nozzle in the vessel and grabbing it with the claw arm;
manipulating the spray nozzle with the claw arm of the device to apply a high pressure fluid stream to the materials to be removed;
directing the high pressure fluid stream to the materials to be removed using the claw arm;
removing the materials from the vessel through vacuum assembly.

26. The method of claim 25, wherein the fluid is water.

27. The method of claim 25, wherein the high pressure fluid stream flows at approximately 100 GPM and approximately 900 PSI.

28. An apparatus for transportation, lowering and raising of a cleaning device, comprising:
a lift platform;
a box having an open top;
two lift arms connected to the box at first ends of the two lift arms such that the arms may rotate relative to the box and connected to the lift platform at second ends of the lift arms via a pair of pin slots on opposite sides of the lift platform;
a pair of cylinders connected to an interior of the box and a bottom surface of the lift platform;
a wench at a first end of the lift platform; and
a plurality of leg extensions extending from lower corners of the box;
wherein the cylinders are configured to raise and lower the lift platform relative to the box;
wherein the lift platform is configured to form a top surface of the box when the lift platform is in a lowered position;
wherein the two lift arms are configured such that, when the lift platform is raised, the lift platform is angled such that the first end of the lift platform is at a highest point of the lift platform; and
wherein the cleaning device may be secured to the lift platform via the wench.

29. The apparatus of claim 28, further comprising a plurality of wheels attached to the plurality of leg extensions.

30. The apparatus of claim 28, wherein the leg extensions are telescoping leg extensions.

31. The apparatus of claim 30, further comprising a plurality of leveling pins attached to the plurality of telescoping leg extensions.

32. The apparatus of claim 28, wherein the pair of cylinders are configured to be contained within the box when the lift platform is fully lowered.

33. The apparatus of claim 29, wherein at least two of the plurality of wheels are swivel wheels.

34. The apparatus of claim 29, wherein at least one of the plurality of wheels includes a locking mechanism.

35. A crane, comprising:
a base including
an annular section extending vertically from a bottom section having a first ring, a second ring, and a third ring formed around the annular section;
a first set of tubes arranged vertically between the first ring and the second ring forming a first set of pin holes;
a second set of tubes arranged vertically between the second ring and the third ring forming a second set of pin holes;
a plurality of leg extensions, each connected to at least one of the first and second sets of pin holes such that the plurality of leg extensions may rotate at a first end of the plurality of leg extensions relative to the first and second sets of pin holes;
an extender connected to the annular section of the base and extending vertically from the base;
a wench connected to the extender;
an arm section including
a connector secured to a top of the extender and extending vertically from the extender;
an arm holder attached to a top portion of the connector and arranged substantially parallel to a surface upon which the crane is installed;
an arm passing within the arm holder and configured to extend or contract relative to the arm holder; and
a wench ring attached at one end of the arm;
wherein the extender is configured to rotate along a central axis relative to the annular section of the base.

36. The crane of claim 35, further comprising a plurality of leveling pins attached to the plurality of leg extensions.

37. The crane of claim 35, wherein each of the plurality of leg extensions has a leg extension member.

38. The crane of claim 35, wherein a circumference of the first ring is substantially the same as a circumference of the second ring.

39. The crane of claim 35, wherein a circumference of the second ring is larger than a circumference of the second ring.

40. A method of removing material from a vessel, comprising:
disassembling a device by releasing twist lock pins, the device including a chassis and a remotely controllable articulating claw assembly connected to the chassis, the claw assembly having at least two joints and configured to manipulate equipment in an interior portion of the vessel, wherein the chassis includes first and second track members attached to a central member via track connections, wherein the first and second track members are configured to collapse such that the track members are close to the central member when in a collapsed position and extended away from the central member when in an expanded position, wherein the first and second track members are attached to the central member via the twist lock pins, the twist lock pins having locking grooves;
transporting the disassembled device in separate pieces to a site for installation;
assembling the device by connecting the first and second tracks to the track extensions via the twist lock pins;
dissembling a crane having a base, the extender, the wench, and the arm section;
transporting the base, the extender, the wench, and the arm section to the site for installation;
assembling the crane at the site for installation;
connecting the wench of the crane to the device;
lowering the device into the vessel via the wench;
removing the material using the device; and
raising the device out of the vessel via the wench.
